(19) United States
(12) Patent Application Publication
(10) Pub. No.: US 2018/0156999 A1
(43) Pub. Date: Jun. 7, 2018

(54) HIGH-DENSITY PORT TAP FIBER OPTIC MODULES, AND RELATED SYSTEMS AND METHODS FOR MONITORING OPTICAL NETWORKS

(71) Applicant: Corning Optical Communications LLC, Hickory, NC (US)

(72) Inventors: Scott Eaker Buff, Hickory, NC (US); Terry Lee Cooke, Hickory, NC (US); Christopher Shawn Houser, Hickory, NC (US); Ronald Alan Leonard, Connelly Springs, NC (US); Brian Keith Rhoney, Denver, NC (US)

(21) Appl. No.: 15/886,402

(22) Filed: Feb. 1, 2018

Related U.S. Application Data
(63) Continuation of application No. 13/663,975, filed on Oct. 30, 2012.
(60) Provisional application No. 61/647,911, filed on May 16, 2012.

(51) Int. Cl. G02B 6/44; G02B 6/28

(52) U.S. Cl. CPC G02B 6/4452; G02B 6/2804; G02B 6/4246

(57) ABSTRACT

Port tap fiber optic modules and related systems and methods for monitoring optical networks are disclosed. In certain embodiments, the port tap fiber optic modules disclosed herein include connections that employ a universal wiring scheme. The universal writing scheme ensure compatibility of attached monitor devices to permit a high density of both live and tap fiber optic connections, and to maintain proper polarity of optical fibers among monitor devices and other devices. In other embodiments, the port tap fiber optic modules are provided as high-density port tap fiber optic modules. The high-density port tap fiber optic modules are configured to support a specified density of live and passive tap fiber optic connections. Providing high-density port tap fiber optic modules can support greater connection bandwidth capacity to provide a migration path for higher data rates while minimizing the space needed for such fiber optic equipment.

### PRIORITY APPLICATION

This application is a continuation of U.S. application Ser. No. 13/663975, filed Oct. 30, 2012, which claims the benefit of priority under 35 U.S.C. § 119 of U.S. Provisional Patent Application Ser. No. 61/647,911, filed on May 16, 2012 the content of which is relied upon and incorporated herein by reference in its entirety.

### BACKGROUND

### Field of the Disclosure

The technology of the disclosure relates to providing fiber optic connections in fiber optic modules configured to be supported in fiber optic equipment.

### Technical Background

Benefits of utilizing optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed for use in delivering voice, video, and data transmissions to subscribers over both private and public networks. These fiber optic networks often include separated connection points linking optical fibers to provide “live fiber” from one connection point to another. In this regard, fiber optic equipment is located in data distribution centers or central offices to support live fiber interconnections. For example, the fiber optic equipment can support interconnections between servers, storage area networks (SANs), and/or other equipment at data centers. Interconnections may be further supported by fiber optic patch panels or modules.

Fiber optic equipment is customized based on application and connection bandwidth needs. The fiber optic equipment is typically included in housings that are mounted in equipment racks to optimize use of space. Many data center operators or network providers also wish to monitor traffic in their networks. Monitoring devices typically monitor data traffic for security threats, performance issues and transmission optimization, for example. Typical users for monitoring technology are highly regulated industries like financial, healthcare or other industries that wish to monitor data traffic for archival records, security purposes, and the like. Thus, monitoring devices allow analysis of network traffic and can use different architectures, including an active architecture such as SPAN (i.e., mirroring) ports, or passive architectures such as port taps. Passive port taps in particular have the advantage of not altering the time relationships of frames, grooming data, or filtering out physical layer packets with errors, and are not dependent on network load.

Fiber optic cables are provided to provide optical connections to fiber optic equipment and monitoring devices. For example, a fiber optic ribbon cable may be employed that includes a ribbon including a group of optical fibers. Optical fiber ribbons can be connected to multi-fiber connectors, such as MTP connectors as a non-limiting example, to provide multi-fiber connections with a connection. Conventional networking solutions are configured in a point-to-point system. Thus, optical fiber polarity, (i.e., based on a given fiber's transmit to receive function in the system) is addressed by flipping optical fibers in one end of the assembly just before entering the multi-fiber connector in an epoxy plug, or by providing “A” and “B” type break-out modules where the fiber is flipped in the “B” module and straight in the “A” module. This optical fiber flipping scheme to maintain fiber polarity can cause complexity when technicians install fiber optic equipment. Technicians must be aware of the break-out type. Also, this optical fiber flipping scheme may also require additional fiber optic equipment to be employed to provided optical fiber tap ports for monitoring live optical fibers.

Further, data rates that may be provided by equipment in a data center are governed by the connection bandwidth supported by the fiber optic equipment. The connection bandwidth is governed by a number of live optical fiber ports included in the fiber optic equipment and the data rate capabilities of a transceiver connected to the live optical fiber ports. When additional bandwidth is needed or desired, additional live fiber optic equipment may be employed or scaled in the data center to increase optical fiber port count. However, increasing the number of live optical fiber ports may require additional equipment rack space in the data center, thereby incurring increased costs. If the live optical fiber ports are to be monitored, increasing the number of live optical fiber ports may also require additional equipment and/or equipment rack space in the data center to provide for additional tap ports to support the increased number of live optical fiber ports. As such, a need exists to provide fiber optic equipment that supports a foundation in data centers for migration to high-density patch fields for live optical fiber ports that can also support high-density tap ports, to provide greater monitored connection bandwidth capacity to provide a migration path for higher data rates while minimizing the space needed for such fiber optic equipment.

### SUMMARY OF THE DETAILED DESCRIPTION

Embodiments of the disclosure include port tap fiber optic modules and related systems and methods for monitoring optical networks. In certain embodiments, the port tap fiber optic modules disclosed herein include connections that employ a universal wiring scheme. The universal wiring scheme ensures compatibility of attached monitor devices to permit a high density of both live and tap fiber optic connections, and to maintain proper polarity of optical fibers among monitor devices and other devices. In other embodiments, the port tap fiber optic modules are provided as high-density port tap fiber optic modules. The high-density port tap fiber optic modules are configured to support a specified density of live and passive tap fiber optic connections. Providing high-density port tap fiber optic modules can support greater connection bandwidth capacity to provide a migration path for higher data rates while minimizing the space needed for such fiber optic equipment.

In this regard, in one embodiment, a high-density port tap fiber optic apparatus is provided. The high-density port tap fiber optic apparatus comprises a chassis having a size based on U space. A U space is defined as having a 1.75 inch height and refers to equipment intended for mounting in a 19-inch rack or a 23-inch equipment rack. The chassis is configured to support a live fiber optic connection density of at least ninety-eight (98) live fiber optic connections per U space based on using at least two live simplex fiber optic components or at least one live duplex fiber optic component. The chassis is also further configured to support a tap fiber optic connection density of at least ninety-eight (98) passive tap fiber optic connections in the U space supporting the live fiber optic connection density.

In another embodiment, a method of supporting a live and tap fiber optic connection density is provided. The method comprises supporting a live fiber optic connection density of at least ninety-eight (98) live fiber optic connections per U space using at least one live simplex fiber optic component or live duplex fiber optic component. The method also comprises supporting a passive tap fiber optic connection density of at least ninety-eight (98) passive taps fiber optic connections in the U space supporting the live fiber optic connection density.

In another embodiment, a high-bandwidth port tap fiber optic apparatus is provided. The high-bandwidth port tap fiber optic apparatus comprises a chassis having a size based on U space. The chassis is configured to support a full-duplex live connection bandwidth of at least nine hundred sixty-two (962) Gigabits per second per U space using at least two live simplex fiber optic components or one live duplex fiber optic component. The chassis is further configured to support a passive tap connection bandwidth of at least nine hundred sixty-two (962) Gigabits per second per U space.

In another embodiment, a method of supporting a live and passive tap fiber optic connection bandwidth is provided. The method comprises supporting a live full-duplex connection bandwidth of at least nine hundred sixty-two (962) Gigabits per second per U space using at least two live simplex fiber optic components or one duplex fiber optic component. The method also comprises supporting a passive taps connection bandwidth of at least nine hundred sixty-two (962) Gigabits per second in the U space supporting the live full-duplex connection bandwidth.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIGS. 1A and 1B, respectively, are perspective and side views of an exemplary port tap fiber optic module according to an exemplary embodiment;

FIG. 2 is a perspective view of an exemplary fiber optic support chassis configured to support the port tap fiber optic module in FIGS. 1A and 1B, according to an exemplary embodiment;

FIG. 3 is a perspective view of a plurality of the port tap fiber optic module in FIGS. 1A and 1B mounted on the fiber optic support chassis of FIG. 2;

FIG. 4 is a view of an exemplary wiring configuration of a port tap fiber optic module according to an exemplary embodiment;

FIGS. 5A-5C, respectively, are perspective views of alternate embodiments of an enclosure of a port tap fiber optic module;

FIG. 6 is an exemplary universal wiring schematic of the port tap fiber optic module of FIG. 4;

FIG. 7 is a wiring schematic of a portion of the wiring configuration illustrated in FIG. 4;

FIG. 8 is a view of another exemplary wiring configuration according to an alternate embodiment;

FIG. 9 is a wiring schematic of a portion of the wiring configuration of FIG. 8;

FIG. 10 is a view of a wiring configuration according to an alternate embodiment;

FIG. 11 is a wiring schematic of a portion of the wiring configuration of FIG. 10;

FIG. 12 is a view of a wiring configuration according to an alternate embodiment;

FIG. 13 is a wiring schematic of a portion of the wiring configuration of FIG. 12;

FIG. 14 is a view of a wiring configuration of a dual port tap fiber optic module according to an alternate embodiment;

FIG. 15A is a wiring schematic of the dual port tap fiber optic module of FIG. 14;

FIG. 15B is a wiring schematic of a portion of the wiring configuration of FIG. 14;

FIG. 16A is a wiring schematic of a dual port tap fiber optic module according to an alternate embodiment;

FIG. 16B is a wiring schematic of a portion of a wiring configuration according to an alternate embodiment;

FIG. 17 is a view of a wiring configuration according to an alternate embodiment;

FIG. 18 is a wiring schematic of a portion of the wiring configuration of FIG. 17;

FIG. 19 is a perspective view of a fiber optic support chassis according to an alternate embodiment; and

FIG. 20 is a front view of a fiber optic support chassis according to an alternate embodiment.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments of the disclosure include port tap fiber optic modules and related systems and methods for monitoring optical networks. In certain embodiments, the port tap fiber optic modules disclosed herein include connections that employ a universal wiring scheme. The universal wiring scheme ensures compatibility of attached monitor devices to permit a high density of both live and tap fiber optic connections, and to maintain proper polarity of optical fibers among monitor devices and other devices. In other embodiments, the port tap fiber optic modules are provided as high-density port tap fiber optic modules. The high-density port tap fiber optic modules are configured to support a specified density of live and passive tap fiber optic connections. Providing high-density port tap fiber optic modules can support greater connection bandwidth capacity to provide a migration path for higher data rates while minimizing the space needed for such fiber optic equipment.

In certain embodiments disclosed herein, high-density port tap fiber optic modules are provided. In one embodiment, a fiber optic apparatus is provided. The high-density fiber optic apparatus comprises a chassis having a size based on U space. A U space is defined as having a 1.75 inch height and refers to equipment intended for mounting in a 19-inch rack or a 23-inch equipment rack. The chassis is configured to support a high-density live fiber optic connection density per U space based on using at least two live simplex fiber optic components or at least one live duplex fiber optic component. The chassis is also further configured to support a high-density tap fiber optic connection density in the U space supporting the live fiber optic connection density.

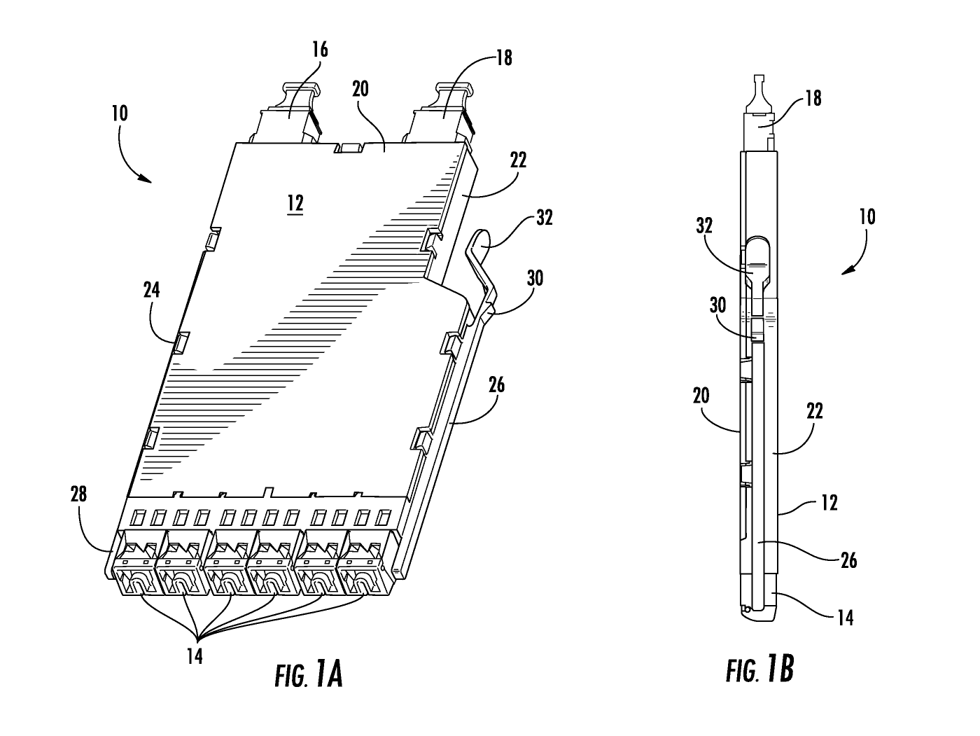

In this regard, FIGS. 1A and 1B, respectively, are perspective and side views of a port tap fiber optic module 10 according to an exemplary embodiment. An enclosure 12 includes a plurality of live lucent connector (LC) fiber optic connectors 14 on a front portion of the enclosure 12, and a live multiple fiber push-on/pull-off (MTP) fiber optic connector 16 on a rear portion of the enclosure 12. The enclosure 12 also includes a tap MTP fiber optic connector 18 on the rear portion of the enclosure 12. The enclosure 12 comprises an enclosure cover 20 that encloses a cavity formed by an enclosure body 22. The enclosure cover 20 is removably held in place by a plurality of tabs 24. The port tap fiber optic module 10 also includes right and left rails 26, 28 for mattingly engaging with a chassis or other support structure. The right rail 26 includes a tab 30 for releasably locking the port tap fiber optic module 10 within a support structure. The tab 30 may be released by manually pressing a release flange 32, as will be described in greater detail below.

The cavity of the enclosure 12 is configured to receive or retain optical fibers or a fiber optic cable harness. Live LC fiber optic connectors 14 may be disposed through a front side of the enclosure 12 and configured to receive fiber optic connectors connected to fiber optic cables (not shown). In one example, the live LC fiber optic connectors 14 may be duplex LC fiber optic adapters that are configured to receive and support connections with duplex LC fiber optic connectors. However, any type of fiber optic connection desired may be provided in the port tap fiber optic module 10. The live LC fiber optic connectors 14 are connected to the live MTP fiber optic connectors 16 disposed through a rear side of the enclosure 12. The tap MTP fiber optic connector 18, disposed through a rear side of the enclosure 12, is connected to both the live LC fiber optic connectors 14 and the live MTP fiber optic connector 16. In this manner, a connection to the live LC fiber optic connector 14 creates a live fiber optic connection with the live MTP fiber optic connector 16, and further permits a tap fiber optic connection via the tap MTP fiber optic connector 18. In this example, the live MTP fiber optic connector 16 and the tap MTP fiber optic connector 18 are both multi-fiber push-on (MPO) fiber optic adapters equipped to establish connections with multiple optical fibers (e.g., either twelve (12) or twenty-four (24) optical fibers). The port tap fiber optic module 10 may also manage polarity between the live and tap fiber optic connectors 14, 16, 18.

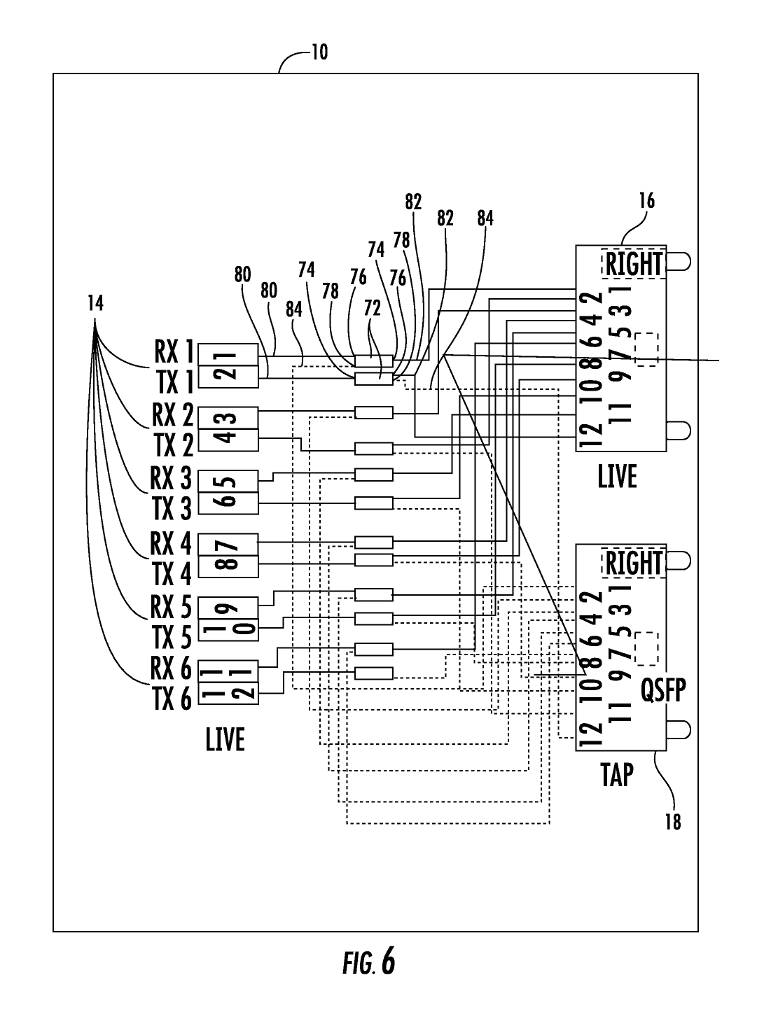

As will be described in greater detail with respect to FIG. 6, the port tap fiber optic module 10 employs a universal wiring scheme to optically connect optical fibers to the various live and tap fiber optic connection sections. Throughout this disclosure, the terms “universal wiring” and “universal wiring scheme” are defined as, and refer to, a wiring scheme for reversing the polarity of optical fibers for transmit/receive fiber pairs/paths, wherein a plurality of pairs of optical fibers are optically connected at one end to a plurality of optical paths (such as a multi-fiber connector) arranged in a generally planar array, with each optical path being immediately adjacent to at least one other optical path, such that at least one of the pairs of optical fibers is connected to optical paths that are not immediately adjacent to each other. In other words, the universal wiring provides easy and straight-forward management of receive-transmit polarity in 2-fiber pair systems. Further, each pair of optical fibers is connected at the other end to a pair of optical paths (such as a duplex connector or a pair of simplex connectors).

In one non-limiting example, a universal wiring scheme may be formed by inserting a conventional twelve-fiber optical ribbon into a multi-fiber connector on one end and routing the optical channel/path to single optical fiber connectors on the other end so that the first six fibers (1-6) are generally aligned with the second six fibers (7-12) for providing correct transmit-receive optical polarity. In this example, providing six optical fiber pairs (1-12, 2-11, 3-10, 4-9, 5-8, 6-7) for transmit-receive optical polarity. By way of example, the universal wiring scheme matches transmit/receive pairs from the middle channels of the multi-fiber ferrule outward to the end channels, thereby yielding the pairing of 1-12 fibers, 2-11 fibers, 3-10 fiber and continuing toward the middle channels of the multi-fiber connector such as listed in the table below. Likewise, a 24-fiber connector could use two 12-fiber groupings to create two sets of transmit/receive pairs in a similar fashion. Ideally, all of the channels of the multi-fiber connector are used to create a high-density solution, but this is not necessary according to the concepts disclosed.

| Pairs | Multi-fiber Connector Channels | Fiber Colors |
|---|---|---|
| 1 | 1-12 (outermost channels) | Blue-Aqua |
| 2 | 2-11 | Orange-Rose |
| 3 | 3-10 | Green-Violet |
| 4 | 4-9 | Brown-Yellow |
| 5 | 5-8 | Slate-Black |
| 6 | 6-7 (middle channels) | White-Red |

As is evident from the numbering of the fibers in each pair, all but one pair are selected from fibers on the optical ribbon that are not adjacent to each other. Each pair can then be separated and connected to a duplex LC connector or a pair of simplex LC connectors. Thus, when each pair of LC connectors is connected to a device that employs transmit and receive signals, the transmit signals are all routed to six adjacent optical paths of the multi-fiber connector, and the receive signals are all received from the other six adjacent optical paths of the multi-fiber connector. Further, the multi-fiber connector may now be directly connected, for example via a flat, twelve-fiber optical ribbon, to another multi-fiber connector connected to a second device by a universal wiring scheme; the transmit signals of the first multi-fiber connector will be routed to the receive ports of the second multi-fiber connector and vice versa.

In this disclosure, the universal wiring schemes are also applied to tap connections in port tap fiber optic modules. In some embodiments, pairs of transmit and receive signals of optical fibers may be passively tapped such that the data carried on both fibers of each pair may be transmitted to respective pairs of tap connections. The tap connections may be pairs of simplex LC connectors, duplex LC connectors, or one or more multi-fiber connectors, for example. When using a universal wiring scheme to output the tap connections via a multi-fiber tap connection, for example, the tap connections may then be easily converted back and forth between LC and MTP configurations with a minimal number of types of connection cabling and other conversion equipment. Using universal wiring also allows for implementation of standardized tap modules that add tap functionality to existing fiber optic wiring modules without sacrificing connection density of the standalone wiring modules. These tap modules are also compatible with existing mounting structures, such as a rack-mount chassis that can accommodate a high density of fiber optic connections.

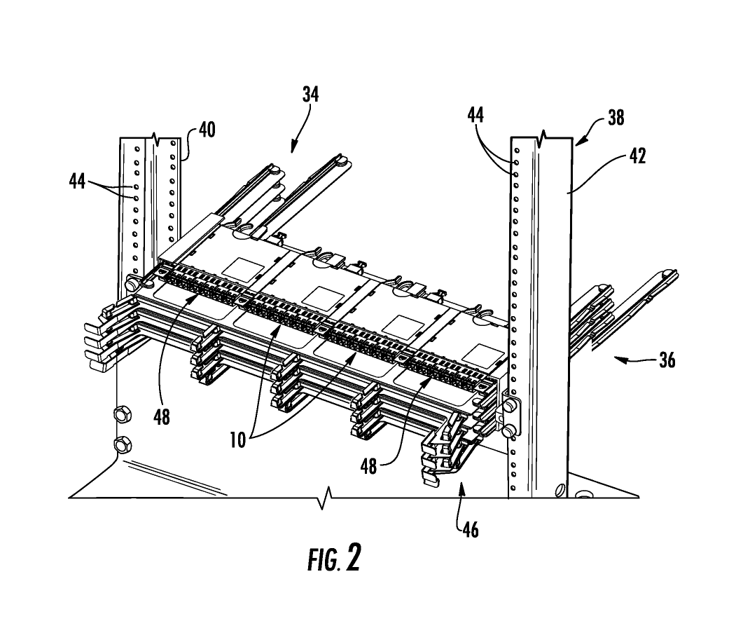

In this regard, FIG. 2 is a perspective view of fiber optic equipment including a support chassis according to an embodiment. In this embodiment, fiber optic equipment 34 includes a chassis 36 supported on a frame 38 comprising a plurality of supports 40, 42. Each support 40, 42 includes a plurality of bores 44 for mounting the chassis 36 to the frame 38. The frame 38 may also include a stiffening member 46 to stiffen the frame 38 and prevent deformation. In this embodiment, the chassis 36 has a plurality of port tap fiber optic modules 10, as well as a plurality of universal fiber optic modules 48. In the following embodiments, a universal fiber optic module 48 includes a plurality of duplex, or pairs of simplex, live LC fiber optic connectors 14 on a front portion of the universal fiber optic module 48, as well as a live MTP fiber optic connector 16 on a rear portion of the universal fiber optic module 48, which is interconnected by a universal wiring scheme, in a similar fashion as the port tap fiber optic module 10. Unlike the port tap fiber optic module 10, however, the universal fiber optic module 48 does not include a tap MTP fiber optic connector 18. In this embodiment, the port tap fiber optic modules 10 and the universal fiber optic modules 48 are interchangeable within the chassis 36.

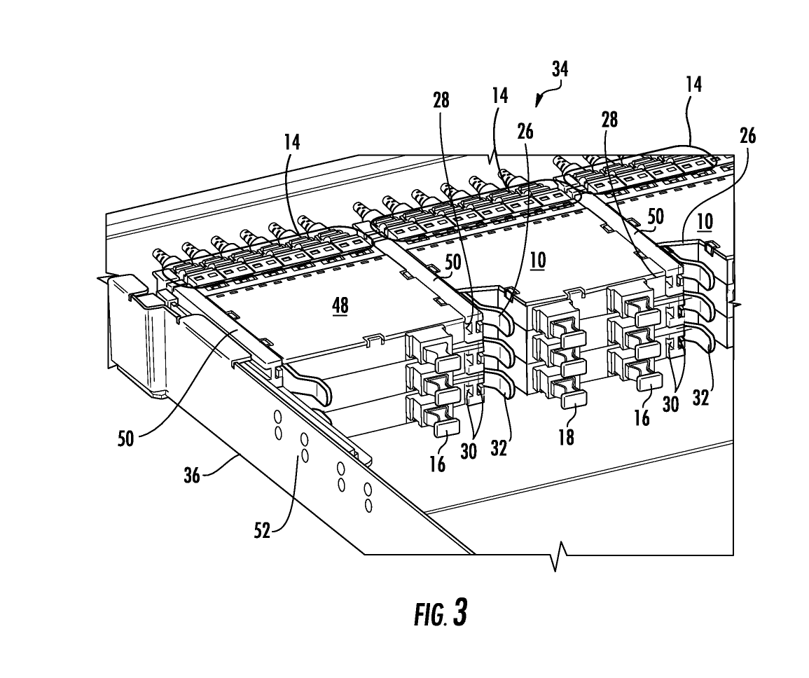

FIG. 3 is a perspective view of a plurality of port tap fiber optic modules mounted in the chassis 36 of FIG. 2. Each port tap fiber optic module 10 and universal fiber optic module 48 is mattingly mounted between a pair of rails 50, which receive right and left rails 26, 28 of each module 10, 48. The rightmost and leftmost rails 50 are bounded by a chassis wall 52.

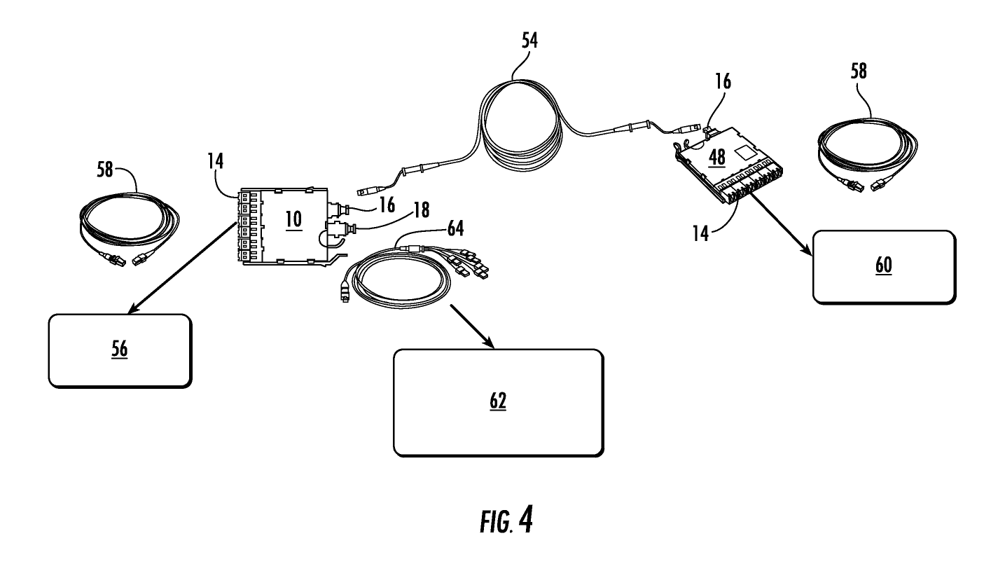

FIG. 4 is a view of a universal wiring configuration in a port tap fiber optic module according to an exemplary embodiment. In this embodiment, a port tap fiber optic module 10 is connected to a universal fiber optic module 48 via an MTP to MTP fiber optic cable 54. Because both the port tap fiber optic module 10 and the universal fiber optic module 48 employ a universal wiring scheme, the MTP to MTP fiber optic cable 54 does not require any correction for polarity, and may employ a simple fiber optic ribbon if desired. The port tap fiber optic module 10 may then be connected to a first device 56 via a plurality of LC to LC fiber optic cables 58 for example; the universal fiber optic module 48 may also be connected to a second device 60 via the plurality of LC to LC fiber optic cables 58. By using this arrangement, the first device 56 can communicate with the second device 60 because all of the transmit paths of the first device 56 lead to the receive paths of the second device 60, and vice versa. The communication between the first device 56 and the second device 60 can now be easily monitored by a monitor device 62 connected to the tap MTP fiber optic connector 18 of the port tap fiber optic module 10 via, for example, a universal MTP to LC fiber optic cable 64 or other suitable interface.

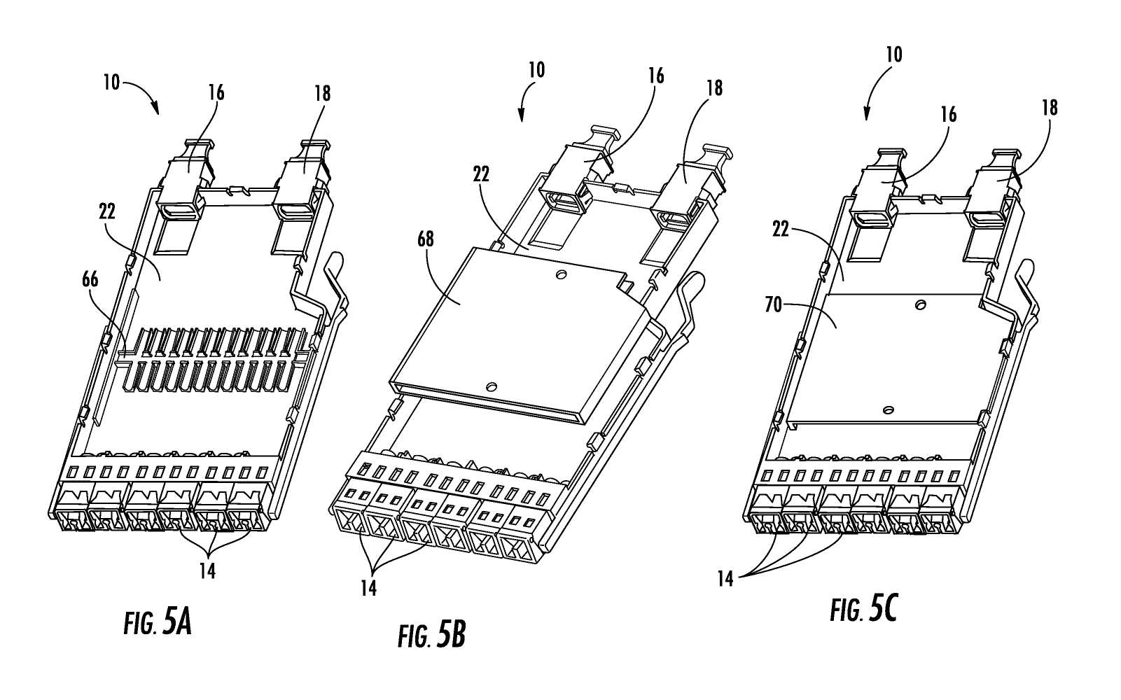

The port tap fiber optic modules can be provided in various packagings with different sizes and footprints. In this regard, FIGS. 5A-5C are perspective views of alternate embodiments of an enclosure of a port tap fiber optic module (for example, the enclosure 12 of the port tap fiber optic module 10) having optional structure. In this embodiment, the internal wiring of the port tap fiber optic module 10 may be managed in a number of different internal structures such as an optional cartridge or the like that aids with organization and handling during manufacturing. The cartridge is disposed within the cavity of the enclosure and may be integrally formed therewith or removably attached. Simply stated, the cartridge provides organization, routing and protection during the manufacturing process and within the port tap module to allow high-density applications without causing undue optical attenuation. The optional splitter cartridge may be attached in any suitable manner such as clips, pins, close-fitting arrangement or the like for ease of installation and assembly. For example, FIG. 5A illustrates a cartridge (not numbered) having plurality of channels 66 for separating and guiding individual fibers among the various live and tap fiber optic connectors 14, 16, 18. FIG. 5B illustrates a cartridge with a frame 68 having a single recess which holds fibers in place while permitting access to the remainder of the port tap fiber optic module 10. FIG. 5C illustrates a removable cover 70 that guides and manages the fibers when the port tap fiber optic module 10 is open. With the structure of the port tap fiber optic module 10 in mind, an exemplary wiring scheme for the port tap fiber optic module 10 is now described in detail.

FIG. 6 is a wiring schematic of the port tap fiber optic module 10 of FIG. 4. In this embodiment, the live MTP fiber optic connector 16 and the tap MTP fiber optic connector 18 each include twelve (12) fiber optic paths, wherein the group of six (6) live duplex LC fiber optic connectors 14 also includes a total of twelve (12) fiber optic paths. Six pairs of fiber optic splitters 72 are disposed in the cavity of the enclosure body 22. Each pair of fiber optic splitters 72 includes a live optical input 74 at one end, as well as a live optical output 76 and a tap optical output 78 at the other end.

Each pair of fiber optic splitters 72 is oriented in a direction opposite the other, such that the pair of fiber optic splitters 72 is configured to receive optical fibers pairs having opposite polarities. In other words, one of the splitters of the pair is orientated for the transmit path and the other splitter of the pair is orientated for the receive path of the 2-fiber pair. A first live fiber group 80 of twelve (12) fibers is optically connected to and extends from the plurality of live LC fiber optic connectors 14. For each pair of fibers of the first live fiber group 80, one fiber of the optical fiber pair is optically connected to the live optical input 74 of one of a pair of fiber optic splitters (e.g., fiber optic splitter 72(2)); the other optical fiber of the optical fiber pair is optically connected to the live optical output 76 of the other of the pair of fiber optic splitters (e.g., fiber optic splitter 72(1)). Meanwhile, a second live fiber group 82 of twelve (12) fibers is optically connected to and extends from the live MTP fiber optic connector 16. Similar to the first live fiber group 80, for each pair of fibers of the second live fiber group 82, one fiber of the optical fiber pair is optically connected to the live optical input 74 of one of a pair of fiber optic splitters (e.g., fiber optic splitter 72(1)), and the other optical fiber of the optical fiber pair is optically connected to the live optical output 76 of the other of the pair of fiber optic splitters (e.g., fiber optic splitter 72(2)).

Finally, a tap fiber group 84 of twelve (12) fibers is optically connected to and extends from the tap MTP fiber optic connector 18. For each pair of fibers of the tap fiber group 84, the optical fibers of the optical fiber pair are optically connected to the respective tap optical output 78 of each of the pair of fiber optic splitters (e.g., the pair of fiber optic splitters 72(1) and 72(2)). Thus, a single port tap fiber optic module 10 employing a universal wiring scheme may permit a throughput of multiple live fiber optic connections while simultaneously monitoring those live connections via a passive tap connection.

In some embodiments, each fiber optic splitter 72 is configured to transmit power in different proportions to the respective live and tap optical outputs 76, 78, based on an amount of power received at the live optical input 74 of the fiber optic splitter 72. In some embodiments, N % of the power received from the live optical input 74 is transmitted to the live optical output 76 of the fiber optic splitter 72 and (100-N)% of the power is transmitted to the tap optical output 78 of the fiber optic splitter 72. N may be any number between and including one (1) and ninety-nine (99). In some embodiments, N may substantially be ninety five (95), seventy (70), fifty (50), or any other number for the desired power split to the tap optical output 78 of the fiber optic splitter 72. N may also be in a range substantially between ninety five (95) and fifty (50), a range substantially between eighty (80) and sixty (60), or any other range to provide the desired power split to the tap optical output 78 of the fiber optic splitter 72.

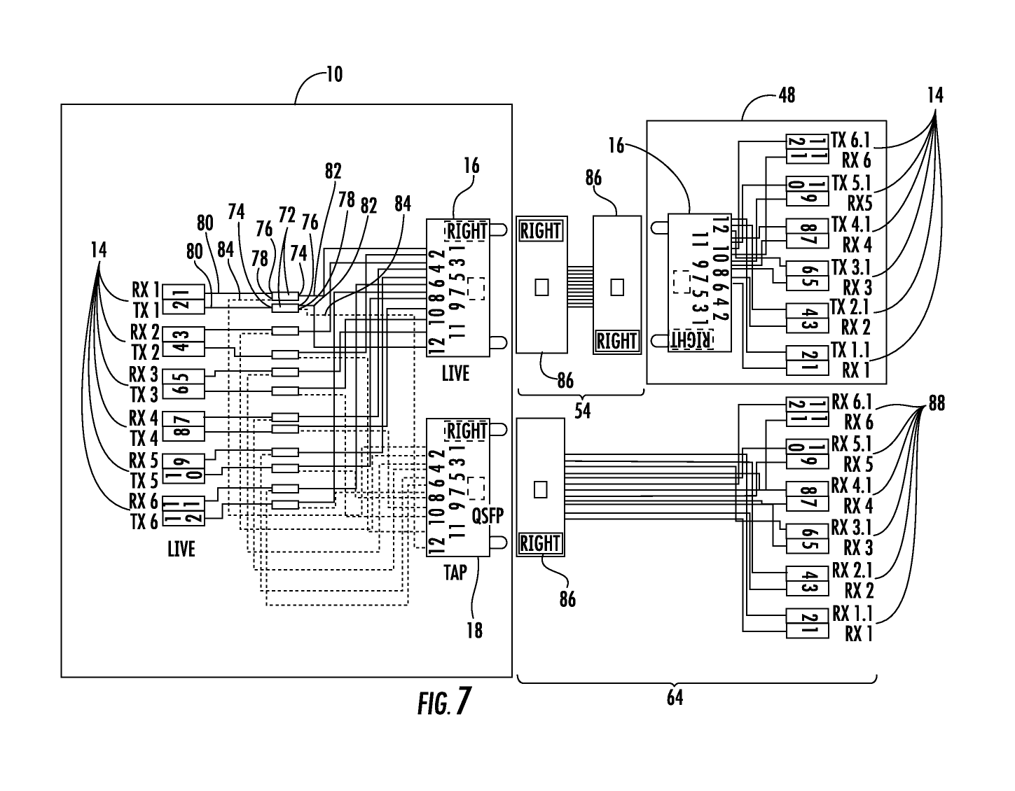

FIG. 7 is a wiring schematic of a portion of the wiring configuration of FIG. 4. The wiring of the port tap fiber optic module 10 has been discussed in detail above with respect to FIG. 6. The wiring of the universal fiber optic module 48 contains a similar universal wiring scheme between a plurality of live LC fiber optic connectors 14 and a live MTP fiber optic connector 16, but does not include a plurality of pairs of fiber optic splitters 72 or a tap MTP fiber optic connector 18, for example. The live LC fiber optic connectors 14 of the port tap fiber optic module 10 and the universal fiber optic module 48 are interconnected by an MTP to MTP fiber optic cable 54. The MTP to MTP fiber optic cable 54 terminates at both ends in a plurality of MTP male connectors 86, each MTP male connector 86 being compatible for optically connecting with the live MTP fiber optic connector 16 of the respective modules 10, 48. In addition, a universal MTP to LC fiber optic cable 64 (which also employs a universal wiring scheme) interconnects the tap MTP fiber optic connector 18 of the port tap fiber optic module 10 to a monitor device 62. The universal MTP to LC fiber optic cable 64 connects to the tap MTP fiber optic connector 18 via an MTP male connector 86, and also connects to a plurality of live LC fiber optic connectors 14 on the monitor device 62 via a plurality of LC connectors 88.

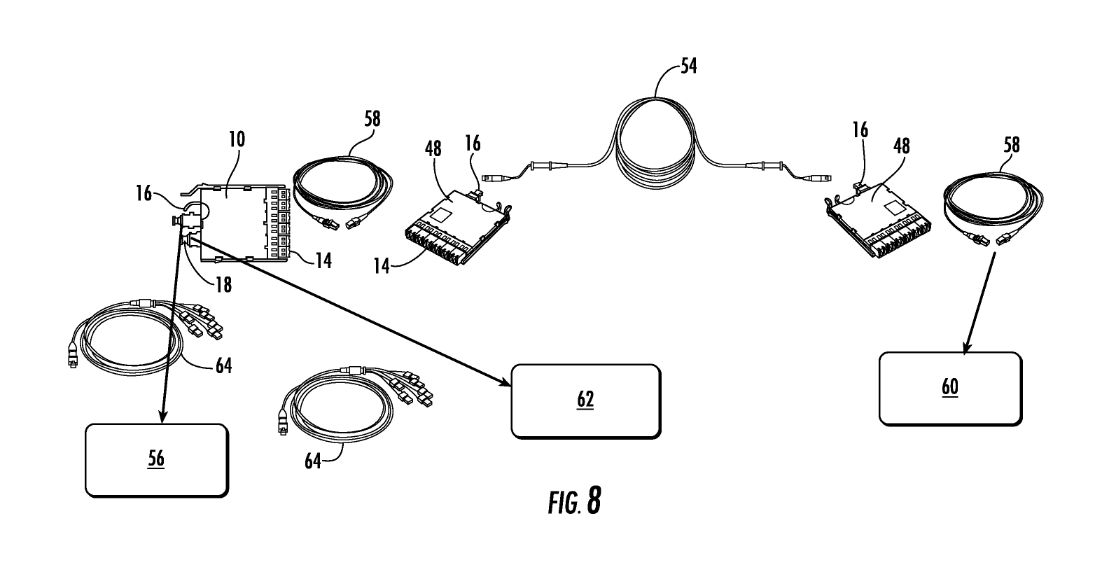

FIG. 8 is a view of a wiring configuration according to another exemplary embodiment. This embodiment illustrates the versatility and variety of configurations using the port tap fiber optic module 10 and other modules. In this configuration, a first device 56 is connected to the live MTP fiber optic connector 16 of the port tap fiber optic module 10 via a universal MTP to LC fiber optic cable 64. The live LC fiber optic connectors 14 of the port tap fiber optic module 10 may then be connected to a second device 60 via a plurality of components connected in series. In this embodiment, the plurality of components comprises a plurality of LC to LC fiber optic cables 58, a universal fiber optic module 48, an MTP to MTP fiber optic cable 54, another universal fiber optic module 48, and another plurality of LC to LC fiber optic cables 58. Finally, a monitor device 62 is connected to the tap MTP fiber optic connector 18 of the port tap fiber optic module 10 via a universal MTP to LC fiber optic cable 64. Thus, both live devices 56, 60 may be connected to each other with any number of modules and connector cables interposed therebetween, so long as the correct polarity is maintained between the devices 56, 60, for example, by using universal wiring schemes.

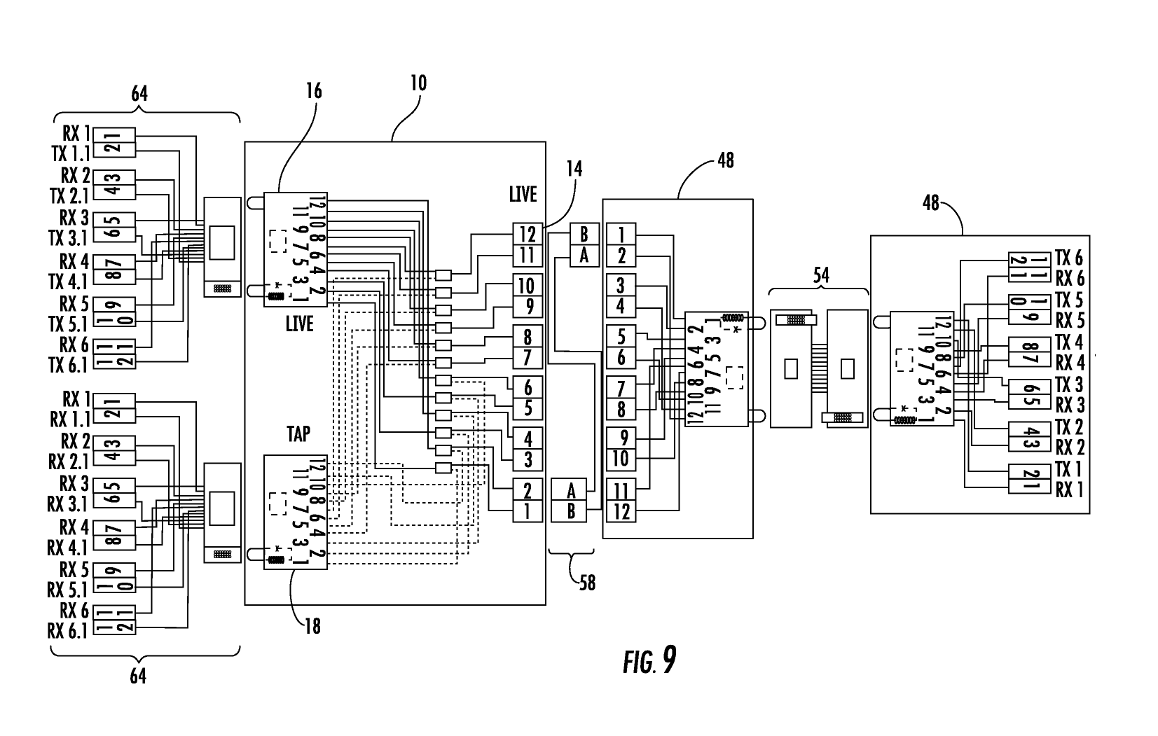

FIG. 9 is a wiring schematic of a portion of the wiring configuration of FIG. 8. Notably, the universal wiring scheme of the live LC fiber optic connectors 14 of the port tap fiber optic module 10 and the universal MTP to LC fiber optic cable 64 permit the plurality of LC connectors 88 of the universal MTP to LC fiber optic cable 64 to be connected directly to the corresponding live LC fiber optic connectors 14 while maintaining a correct polarity configuration for all live fiber optic connections. Likewise, as with the configuration in FIG. 4, a monitor device 62 may be easily connected to the port tap fiber optic module 10 via a universal MTP to LC fiber optic cable 64, for example.

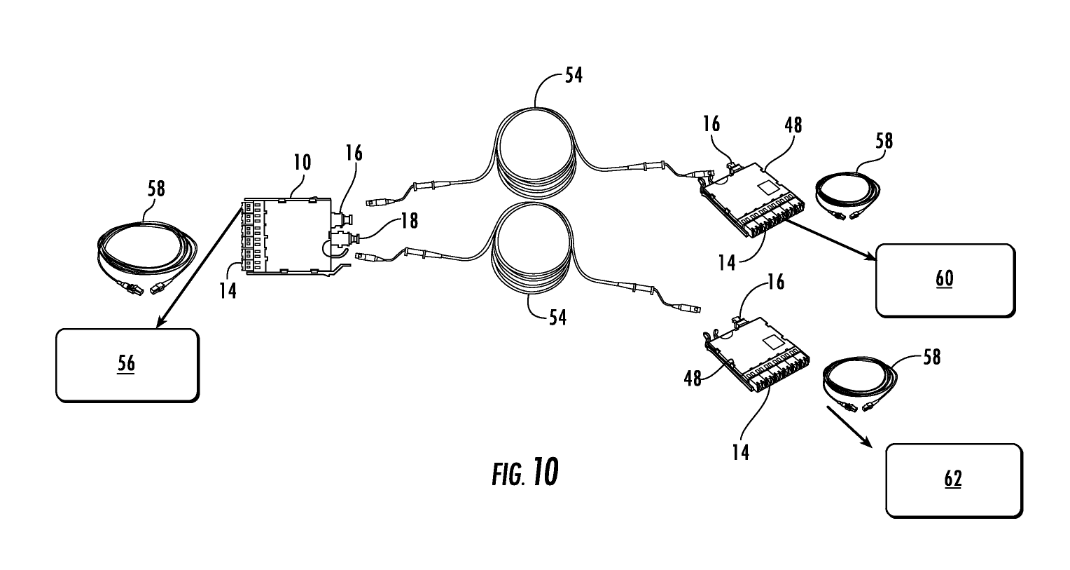

FIG. 10 is a view of a wiring configuration according to an alternate embodiment. Here, just as any number of modules and connector cables may be interposed between the devices 56, 60, so long as the monitor device 62 is connected directly or indirectly to the tap MTP fiber optic connector 18 with correct polarity, any number of modules and connector cables may be interposed therebetween as well. In this embodiment, a first device 56 is connected to the live LC fiber optic connectors 14 of the port tap fiber optic module 10 via a plurality of LC to LC fiber optic cables 58. The live MTP fiber optic connector 16 is connected to a second device 60 via a universal fiber optic module 48 and an MTP to MTP fiber optic cable 54 connected in series. The tap MTP fiber optic connector 18 is connected to a monitor device 62 via a universal fiber optic module 48 and an MTP to MTP fiber optic cable 54 connected in series.

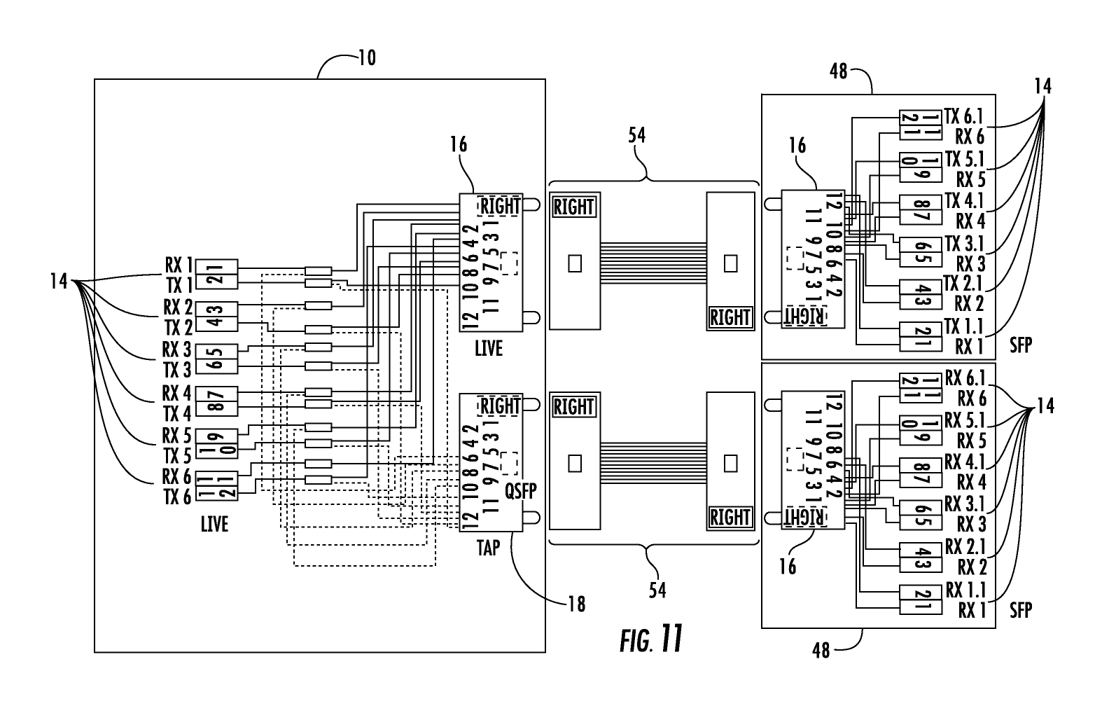

FIG. 11 is a wiring schematic of a portion of the wiring configuration of FIG. 10. Similar to FIGS. 7 and 9 above, the universal wiring schemes used by the live and tap fiber optic connectors 16, 18 permit the used of a standard MTP to MTP fiber optic cable 54 to connect the universal fiber optic modules 48 to the port tap fiber optic module 10.

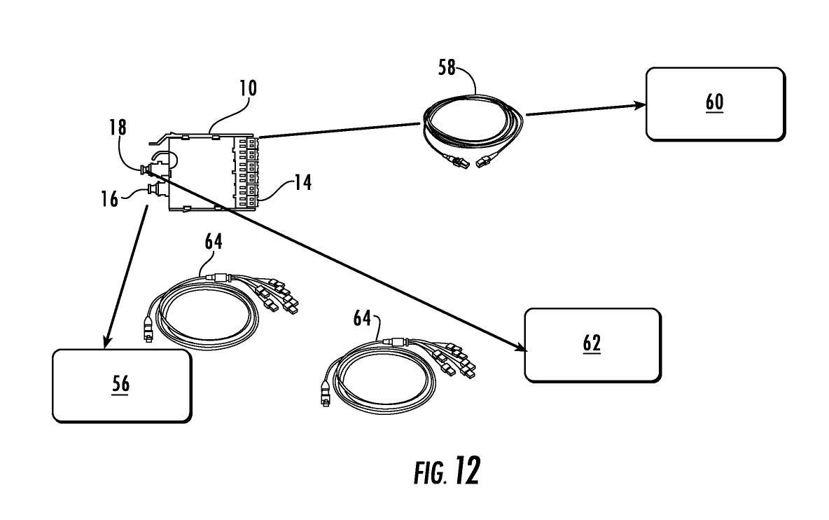

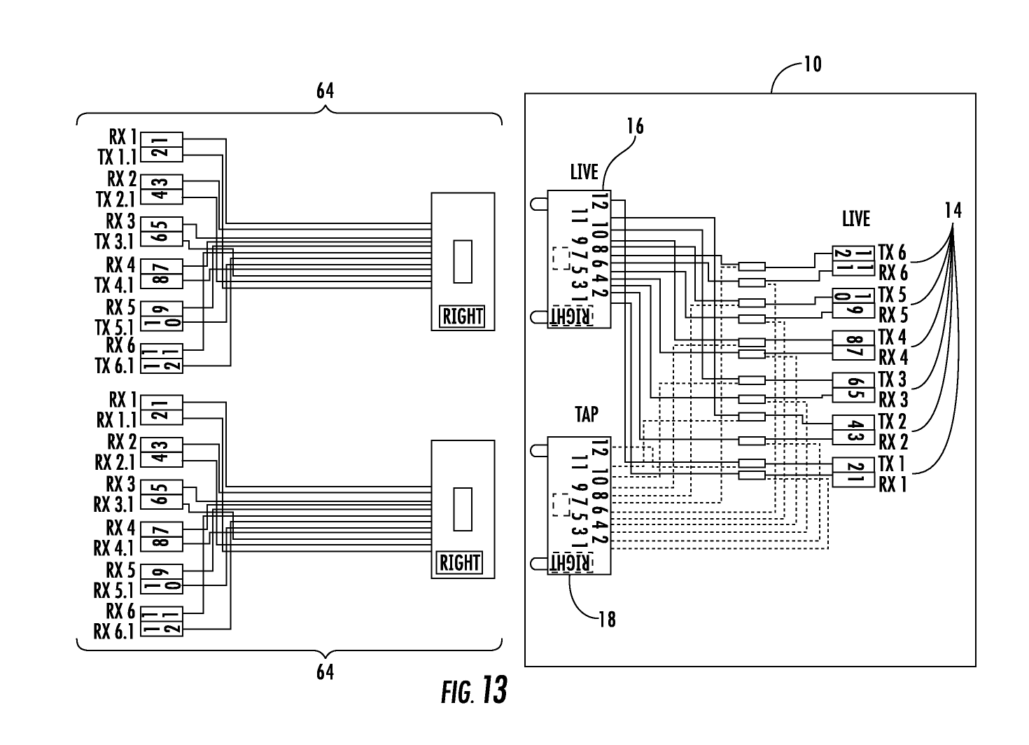

FIG. 12 is a view of a more simplified wiring configuration according to an alternate embodiment. Just as a large number of connector cables and modules may be interposed between live and tap devices, the port tap fiber optic module 10 may also be directly connected to all three devices. Here, the first and second devices 56, 60 are connected directly to the live fiber optic connectors 14, 16, and the monitor device 62 is connected directly to the tap MTP fiber optic connector 18. The live MTP fiber optic connector 16 of the port tap fiber optic module 10 is connected directly to the first device 56 via a universal MTP to LC fiber optic cable 64. The live LC fiber optic connectors 14 of the port tap fiber optic module 10 are connected directly to the second device 60 via a plurality of LC to LC fiber optic cables 58. The tap MTP fiber optic connector 18 of the port tap fiber optic module 10 is connected directly to a monitor device 62 via a universal MTP to LC fiber optic cable 64. FIG. 13 is a wiring schematic of a portion of the wiring configuration of FIG. 12.

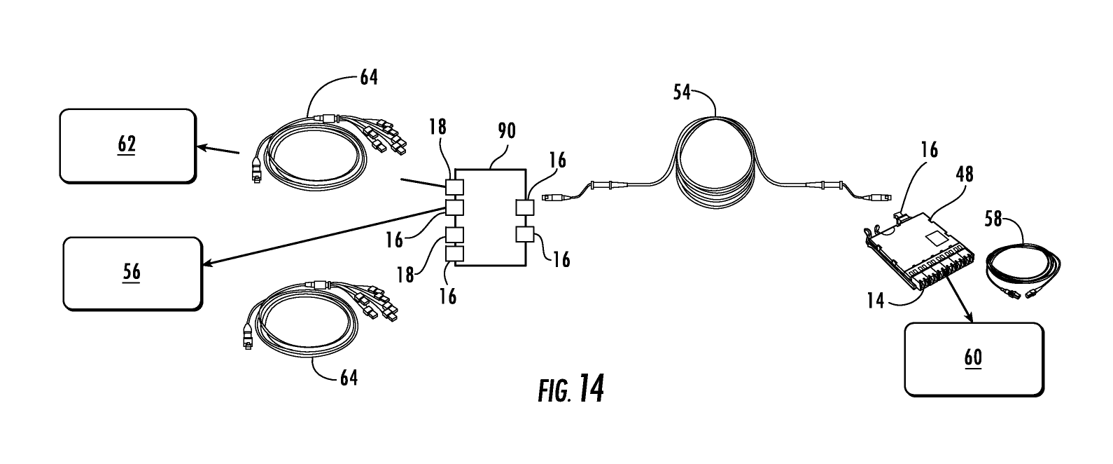

FIG. 14 is a view of a wiring configuration according to an alternate embodiment in which a higher density dual port tap fiber optic module 90 is employed. The dual port tap fiber optic module 90 is used to connect two pairs of live devices 56, 60 and a corresponding monitor device 62 for each pair of live devices. The dual port tap fiber optic module 90 has a similarly sized enclosure 12 as the port tap fiber optic module 10, which is sized to accommodate up to four live and/or tap MTP fiber optic connectors 16, 18 on the front and back sides of the enclosure 12, for a maximum of eight live and/or tap MTP fiber optic connectors 16, 18 per module 10, 90. In this embodiment, the dual port tap fiber optic module 90 includes two live MTP fiber optic connectors 16 on each side of the enclosure 12 and two tap MTP fiber optic connectors 18. In this embodiment, the dual port tap fiber optic module 90 does not include a universal wiring scheme. In some wiring scenarios, it may be desirable to employ universal wiring only when converting back and forth between MTP and LC connections. Since no MTP/LC conversion takes place within the dual port tap fiber optic module 90, polarity adjustments may be achieved by a universal MTP to LC fiber optic cable 64 or a universal fiber optic module 48 connected to a respective live and/or tap MTP fiber optic connector 16, 18.

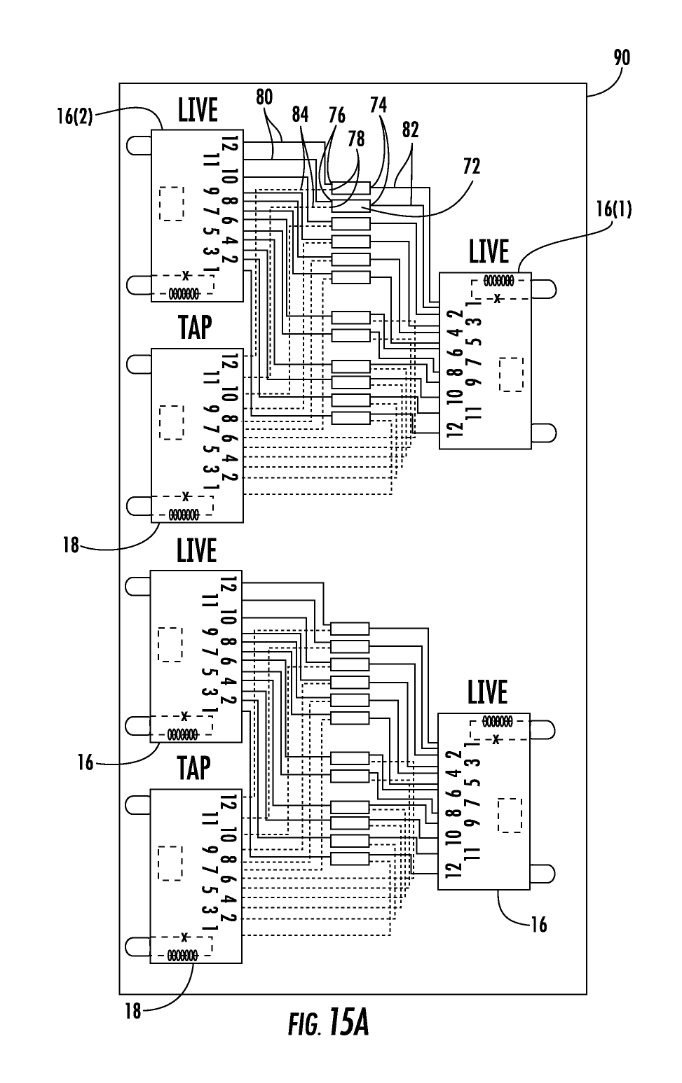

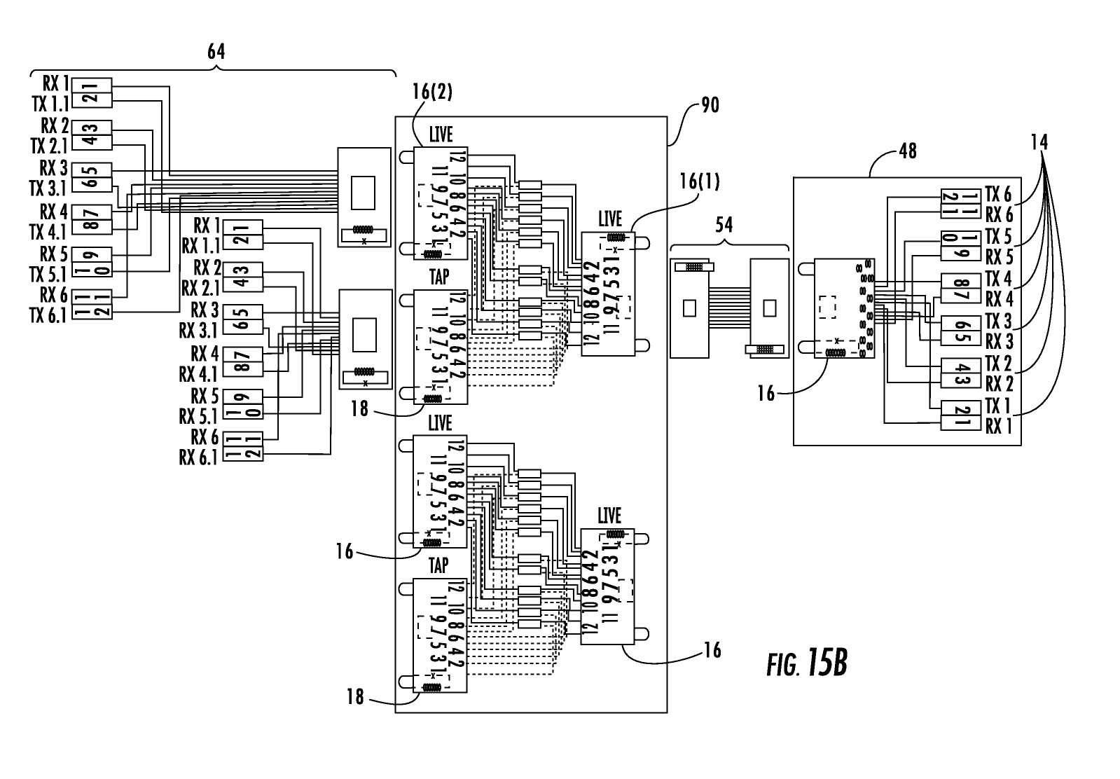

FIG. 15A is a wiring schematic of the dual port tap fiber optic module 90 of FIG. 14. As discussed above, rather than employ a universal wiring scheme within the dual port tap fiber optic module 90, each live MTP fiber optic connector 16 passes a fiber optic signal of six numbered paths to an opposite numbered path of the other live MTP fiber optic connector 16 via two sets of optical fibers 82 that connect to the plurality of pairs of fiber optic splitters 72. The tap MTP fiber optic connector 18 taps the transmit signals in both directions from the respective sets of six adjacent optical fibers 82. The transmit signals are then sent from the tap optical output 78 of each pair of fiber optic splitters 72 along a plurality of optical fibers 84 to the tap MTP fiber optic connector 18.

FIG. 15B is a wiring schematic of a portion of the wiring configuration of FIG. 14. As discussed above, when converting transmit signals for use with a device using pairs of live LC fiber optic connectors 14, the polarity adjustment is achieved either by a universal MTP to LC fiber optic cable 64 or by a serial connection to either an MTP to MTP fiber optic cable 54, a universal fiber optic module 48, and/or a plurality of LC to LC fiber optic cables 58.

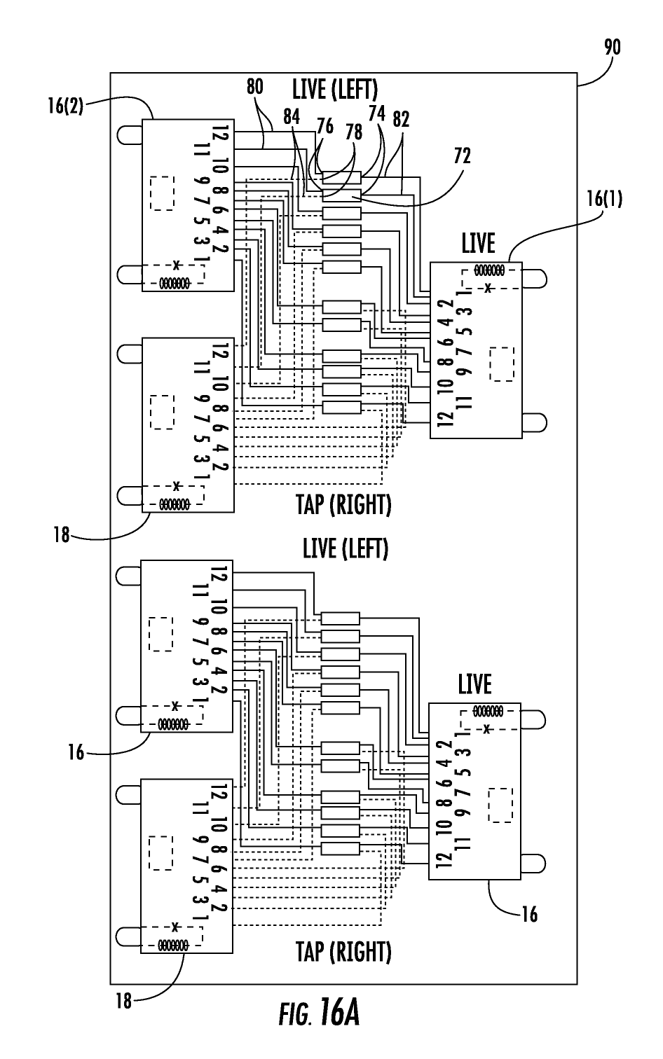

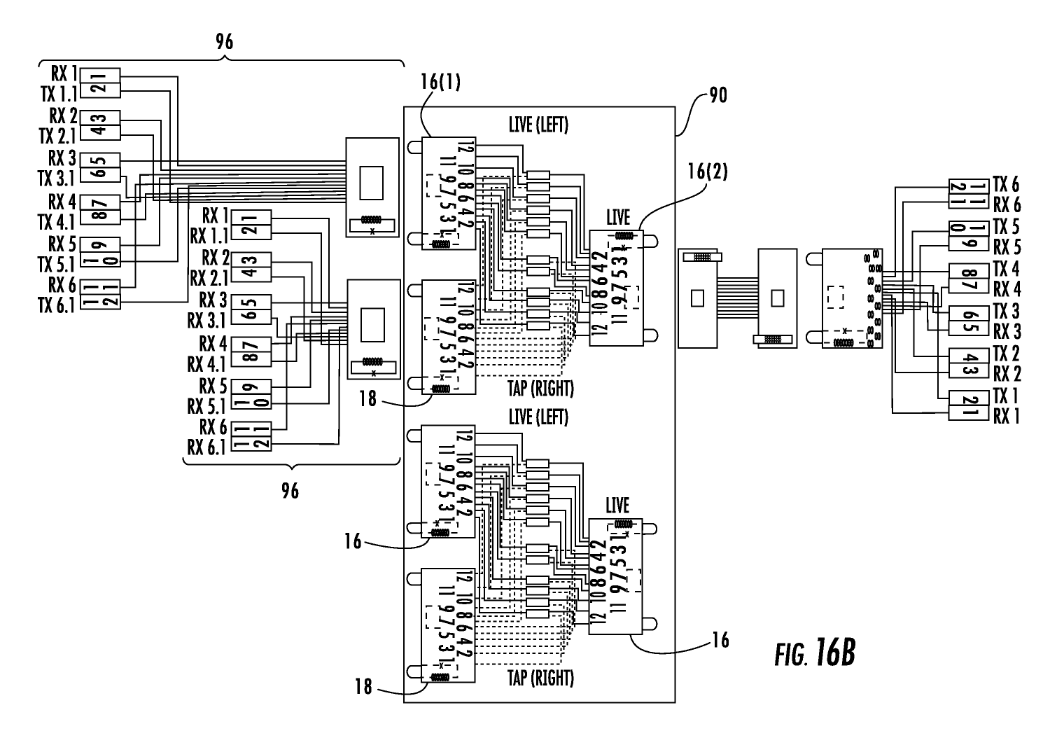

FIG. 16A is a wiring schematic of a dual port tap fiber optic module 90 according to an alternate embodiment. In this embodiment, the dual port tap fiber optic module 90 employs a universal wiring scheme at a live MTP fiber optic connector 16(1) to permit use of a standard MTP to LC fiber optic cable 96 (see FIG. 16B) connecting to another live MTP fiber optic connector 16(2) and a tap MTP fiber optic connector 18.

FIG. 16B is a wiring schematic of a wiring configuration using the dual port tap fiber optic module 90. As discussed above, the universal wiring scheme of the live MTP fiber optic connector 16(1) permits the use of a standard MTP to LC fiber optic cable 96 between the live MTP fiber optic connector 16(2) and a device, and also between the tap MTP fiber optic connector 18 and a monitoring device 62 (not shown).

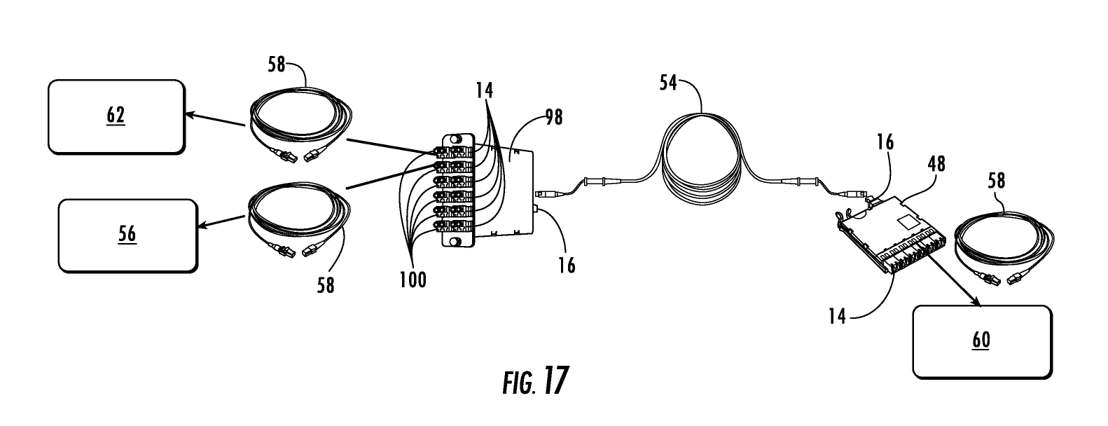

FIG. 17 is a view of a wiring configuration according to an alternate embodiment in which an alternate port tap fiber optic module 98 having tap LC fiber optic connectors 100 is employed. The port tap fiber optic module 98 includes a live MTP fiber optic connector 16 and a plurality of live LC fiber optic connectors 14, as well as a plurality of tap LC fiber optic connectors 100. A first device 56 is connected to the live LC fiber optic connectors 14 via a plurality of LC to LC fiber optic cables 58. A second device 60 is connected to the live MTP fiber optic connector 16 via an MTP to MTP fiber optic cable 54 connected in series with a universal fiber optic module 48 and a plurality of LC to LC fiber optic cables 58. A monitor device 62 is connected to the tap LC fiber optic connectors 100 via a plurality of LC to LC fiber optic cables 58.

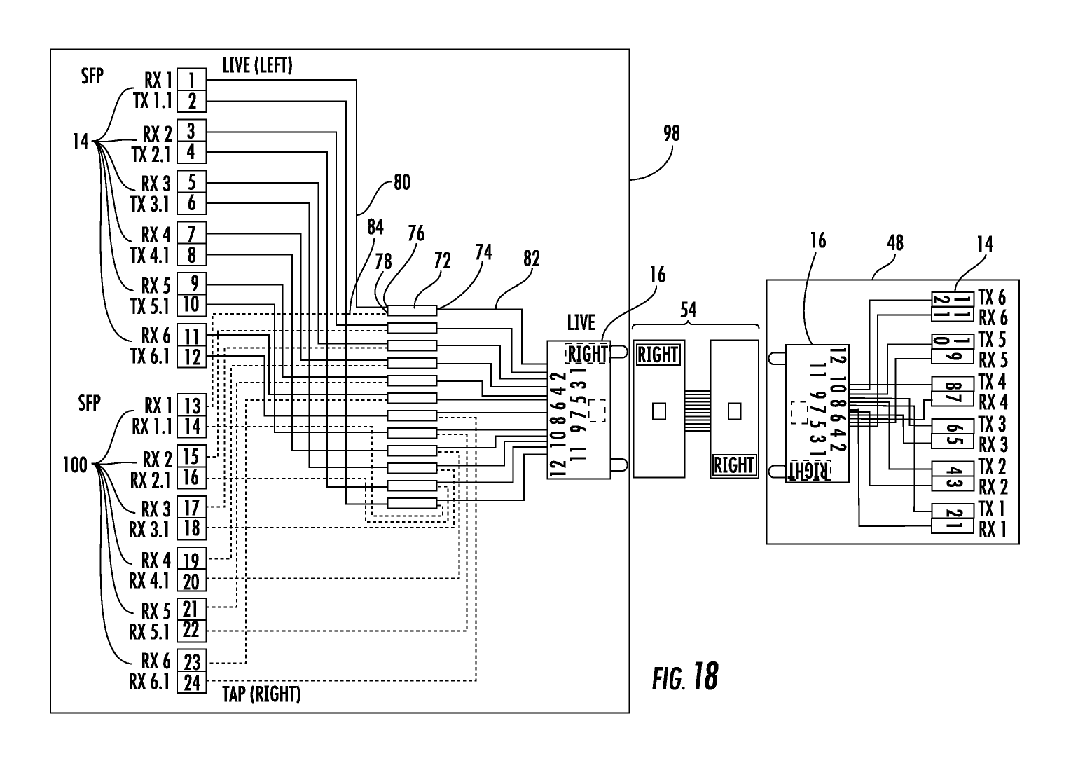

FIG. 18 is a wiring schematic of a portion of the wiring configuration of FIG. 17. To maintain proper polarity for both the live LC fiber optic connectors 14 and the tap LC fiber optic connectors 100, the live MTP fiber optic connector 16 has a universal wiring scheme for both the live LC fiber optic connectors 14 and the tap LC fiber optic connectors 100.

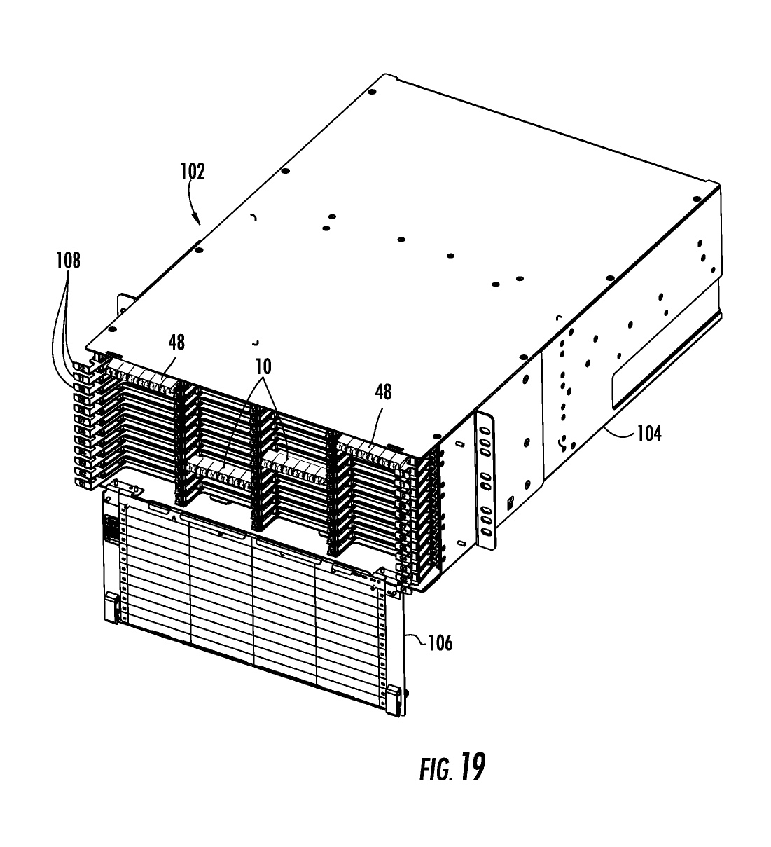

FIG. 19 is a perspective view of a fiber optic support chassis 102 according to an alternate embodiment. The fiber optic support chassis 102 includes a housing 104 with a hinged door 106 that houses a plurality of trays 108 for mounting a plurality of port tap fiber optic modules 10, universal fiber optic modules 48, and/or other compatible equipment. The housing 104 may be sized to standardized dimensions, such as to a 1-U or a 3-U space.

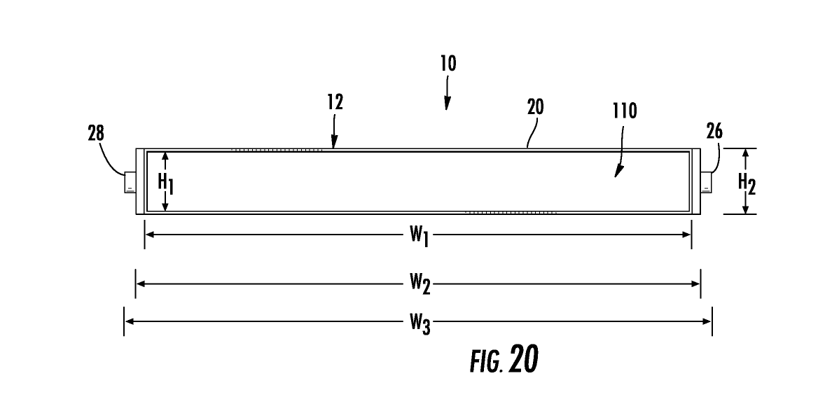

In addition to the versatility of the different configurations described above, another advantage of the described embodiments is that live and tap fiber optic connections can be densely arranged, for example, within the limited space of a 1-U or 3-U space. FIG. 20 is a front view of a portion of the port tap fiber optic module 10 described above and illustrated in FIGS. 1A and 1B without fiber optic components loaded in the front side to further illustrate the form factor of the port tap fiber optic module 10. In this embodiment, the live LC fiber optic connectors 14 are disposed through a front opening 110 in the front side of the enclosure 12. The greater the width W₁ of the front opening 110, the greater the number of fiber optic components that may be disposed in the port tap fiber optic module 10. Greater numbers of fiber optic components equate to more fiber optic connections, which support higher fiber optic connectivity and bandwidth. However, the larger the width W₁ of the front opening 110, the greater the area required to be provided in a chassis, such as the chassis 36 (shown in FIG. 2), for the port tap fiber optic module 10. Thus, in this embodiment, the width W₁ of the front opening 110 is designed to be at least eighty-five percent (85%) of the width W₂ of a front side of the enclosure 12 of the port tap fiber optic module 10. The greater the percentage of the width W₁ to the width W₂, the larger the area provided in the front opening 110 to receive fiber optic components without increasing the width W₂. A width W₃, the overall width of the port tap fiber optic module 10, may be 86.6 millimeters or 3.5 inches in this embodiment. The port tap fiber optic module 10 is designed such that four (4) port tap fiber optic modules 10 may be disposed in a 1/3-U space or twelve (12) port tap fiber optic modules 10 may be disposed in a 1-U space in the chassis 36. The width of the chassis 36 is designed to accommodate a 1-U space width in this embodiment.

It should be noted that 1-U or 1-RU-sized equipment refers to a size standard for rack and cabinet mounts and other equipment, with “U” or “RU” equal to a standard 1.75 inches in height and nineteen (19) inches in width. In certain applications, the width of “U” may be twenty-three (23) inches. In this embodiment, the chassis 36 is 1-U in size; however, the chassis 36 could be provided in a size greater than 1-U as well.

In many embodiments, the port tap fiber optic module 10 and universal fiber optic module 48 are both approximately 1/3 U in height. Thus, with three (3) fiber optic equipment trays 108 disposed in the 1-U height of the chassis 36, a total of twelve (12) port tap fiber optic modules 10 may be supported in a given 1-U space. Supporting up to twelve (12) live fiber optic connections per port tap fiber optic module 10 equates to the chassis 36 supporting up to one hundred forty-four (144) live fiber optic connections, or seventy-two (72) duplex channels, in a 1-U space in the chassis 36 (i.e., twelve (12) fiber optic connections X twelve (12) port tap fiber optic modules 10 in a 1-U space). Thus, the chassis 36 is capable of supporting up to one hundred forty-four (144) live fiber optic connections in a 1-U space by twelve (12) simplex or six (6) duplex fiber optic adapters being disposed in the port tap fiber optic modules 10. Likewise, each port tap fiber optic module 10 also supports the same number of tap fiber optic connections via the tap MTP fiber optic connector 18, which supports twelve (12) tap fiber optic connections. Thus, the chassis 36 is capable of supporting up to one hundred forty-four (144) tap fiber optic connections in a 1-U space by twelve (12) tap MTP fiber optic connectors 18.

The width W₁ of the front opening 110 could be designed to be greater than eighty-five percent (85%) of the width W₂. For example, the width W₁ could be designed to be between ninety percent (90%) and ninety-nine percent (99%) of the width W₂. As an example, the width W₁ could be less than ninety (90) millimeters (mm). As another example, the width W₁ could be less than eighty-five (85) mm or less than eighty (80) mm. For example, the width W₁ may be eighty-three (83) mm and the width W₂ may be eighty-five (85) mm, for a ratio of width W₁ to width W₂ of 97.6%. In this example, the front opening 110 may support twelve (12) fiber optic connections in the width W₁ to support a fiber optic connection density of at least one fiber optic connection per 7.0 mm of width W₁ of the front opening 110. Further, the front opening 110 may support twelve (12) fiber optic connections in the width W₁ to support a fiber optic connection density of at least one fiber optic connection per 6.9 mm of width W₁ of the front opening 110.

With an increase in fiber optic connection density comes a commensurate increase in data bandwidth through the live LC and MTP fiber optic connectors 14, 16 and through the tap MTP fiber optic connector 18. For example, two (2) optical fibers duplexed for one (1) transmission/reception pair may allow for a data rate of ten (10) Gigabits per second in half-duplex mode, or twenty (20) Gigabits per second in full-duplex mode. As another example, eight (8) optical fibers in a twelve (12) fiber MPO fiber optic connector duplexed for four (4) transmission/reception pairs may allow for a data rate of forty (40) Gigabits per second in half-duplex mode, or eighty (80) Gigabits per second in full-duplex mode. As another example, twenty optical fibers in a twenty-four (24) fiber MPO fiber optic connector duplexed for ten (10) transmission/reception pairs may allow for a data rate of one hundred (100) Gigabits per second in half-duplex mode, or two hundred (200) Gigabits per second in full-duplex mode. Because the tap MTP fiber optic connector 18 does not interfere with live connection density in many embodiments, the port tap fiber optic module 10 can simultaneously support equal live and tap connection bandwidths.

Thus, with the above-described embodiment, providing at least seventy-two (72) live duplex transmission and reception pairs in a 1-U space employing at least one duplex or simplex fiber optic component can support a data rate of at least seven hundred twenty (720) Gigabits per second in half-duplex mode in a 1-U space, or at least one thousand four hundred forty (1440) Gigabits per second in a 1-U space in full-duplex mode, including a commensurate tap data rate if employing a ten (10) Gigabit transceiver. This configuration can also support at least six hundred (600) Gigabits per second in half-duplex mode in a 1-U space and at least one thousand two hundred (1200) Gigabits per second in full-duplex mode in a 1-U space, respectively, and a commensurate tap data rate, if employing a one hundred (100) Gigabit transceiver. This configuration can also support at least four hundred eighty (480) Gigabits per second in half-duplex mode in a 1-U space and nine hundred sixty (960) Gigabits per second in full duplex mode in a 1-U space, respectively, and a commensurate tap data rate, if employing a forty (40) Gigabit transceiver. Note that these embodiments are exemplary and are not limited to the above fiber optic connection densities and bandwidths.

Alternate port tap fiber optic modules with alternative fiber optic connection densities are also possible. For example, up to four (4) MPO fiber optic adapters can be disposed through the front opening 110 of the port tap fiber optic module 90. Thus, if the MPO fiber optic adapters support twelve (12) fibers, the port tap fiber optic module 90 can support up to twenty four (24) live fiber optic connections via four live MTP fiber optic connectors 16 and twenty four (24) tap fiber optic connections via two tap MTP fiber optic connectors 18 (as shown in FIG. 14). Thus, in this example, if up to twelve (12) port tap fiber optic modules 90 are provided in the fiber optic equipment trays of the chassis 36 (shown in FIG. 2), up to two hundred eighty eight (288) live fiber optic connections and two hundred eighty eight (288) tap fiber optic connections can be supported by the chassis 36 in a 1-U space.

If the four MPO fiber optic adapters disposed in the port tap fiber optic module 90 support twenty-four (24) fibers, the port tap fiber optic module 90 can support up to forty eight (48) live fiber optic connections and forty eight (48) tap fiber optic connections. Thus, in this example, up to five hundred seventy six (576) live fiber optic connections and five hundred seventy six (576) tap fiber optic connections can be supported by the chassis 36 in a 1-U space.

Further, with the above-described embodiment, providing at least two hundred eighty eight (288) live duplex transmission and reception pairs in a 1-U space employing at least one twenty-four (24) fiber MPO fiber optic components can support a live and tap data rate of at least two thousand eight hundred eighty (2880) Gigabits per second in half-duplex mode in a 1-U space, or at least five thousand seven hundred sixty (5760) Gigabits per second in a 1-U space in full-duplex mode if employing a ten (10) Gigabit transceiver. This configuration can also support at least two thousand four hundred (2400) Gigabits per second in half-duplex mode in a 1-U space and at least four thousand eight hundred (4800) Gigabits per second in full-duplex mode in a 1-U space, respectively, if employing a one hundred (100) Gigabit transceiver.

Thus, in summary, the table below summarizes some of the fiber optic live connection densities and bandwidths that are possible to be provided in a 1-U and 4-U space employing the various embodiments of fiber optic tap modules, fiber optic equipment trays, and chassis described above. For example, two (2) optical fibers duplexed for one (1) transmission/reception pair can allow for a data rate of ten (10) Gigabits per second in half-duplex mode or twenty (20) Gigabits per second in full-duplex mode. As another example, eight (8) optical fibers in a twelve (12) fiber MPO fiber optic connector duplexed for four (4) transmission/reception pairs can allow for a data rate of forty (40) Gigabits per second in half-duplex mode or eighty (80) Gigabits per second in full-duplex mode. As another example, twenty optical fibers in a twenty-four (24) fiber MPO fiber optic connector duplexed for ten (10) transmission/reception pairs can allow for a data rate of one hundred (100) Gigabits per second in half-duplex mode or two hundred (200) Gigabits per second in full-duplex mode. Note that this table is exemplary and the embodiments disclosed herein are not limited to the fiber optic connection densities and bandwidths provided below.

| | | | Number of | Number of | | | | | |
|---|---|---|---|---|---|---|---|---|---|
| | Live and Tap | Live and Tap | Connectors | Connectors | Total Bandwidth per | | Total Bandwidth per | | Total Bandwidth per |
| Connector | Fibers per | Fibers per | per 1 RU | per 4 RU | 1 U using 10 Gigabit | | 1 U using 40 Gigabit | | 1 U using 100 Gigabit |
| Type | 1RU | 4RU | Space | Space | Transceivers (duplex) | | Transceivers (duplex) | | Transceivers (duplex) |
| Duplexed LC | 144 | 576 | 72 | 288 | 1,440 | Gigabits/s. | 960 | Gigabits/s. | 1,200 Gigabits/s. |
| 12-F MPO | 576 | 2,304 | 48 | 192 | 5,760 | Gigabits/s | 3,840 | Gigabits/s. | 4,800 Gigabits/s. |
| 24-F MPO | 1,152 | 4,608 | 48 | 192 | 11,520 | Gigabits/s. | 7,680 | Gigabits/s. | 9,600 Gigabits/s. |

As used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. Non-limiting examples of bend-insensitive, or bend resistant, optical fibers are ClearCurve® Multimode or single-mode fibers commercially available from Corning Incorporated. Suitable fibers of these types are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A high-density port tap fiber optic apparatus, comprising:
a chassis having a size based on U space;
wherein the chassis is configured to support a live fiber optic connection density of at least ninety-eight (98) live fiber optic connections per U space based on using at least two live simplex fiber optic component or at least one live duplex fiber optic component; and
wherein the chassis is further configured to support a tap fiber optic connection density of at least ninety-eight (98) passive tap fiber optic connections in the U space supporting the live fiber optic connection density.

2. The high-density port tap fiber optic apparatus of claim 1, wherein:
the chassis is configured to support the live fiber optic connection density of at least one hundred twenty (120) live fiber optic connections per the U space based on using at least one live simplex fiber optic components or live duplex fiber optic component; and
the chassis is configured to support the passive tap fiber optic connection density of at least one hundred twenty (120) passive tap fiber optic connections in the U space supporting the live fiber optic connection density.

3. The high-density port tap fiber optic apparatus of claim 1, wherein:
the chassis is configured to support the live fiber optic connection density of at least one hundred forty-four (144) fiber optic connections per the U space based on using at least one live simplex fiber optic components or live duplex fiber optic component; and
the chassis is configured to support the passive tap fiber optic connection density of at least one hundred forty-four (144) passive tap fiber optic connections in the U space supporting the live fiber optic connection density.

4. The high-density port tap fiber optic apparatus of claim 1, wherein;
the at least two live simplex fiber optic components or the at least one live duplex fiber optic component is comprised of at least ninety-eight (98) live simplex fiber optic components; and
the tap fiber optic connection density is comprised of at least ninety-eight (98) passive tap simplex fiber optic connections.

5. The high-density port tap fiber optic apparatus of claim 1, wherein:
the at least two live simplex fiber optic components or the at least one live duplex fiber optic component is comprised of at least one hundred twenty (120) live simplex fiber optic components; and
the tap fiber optic connection density is comprised of at least one hundred twenty (120) passive tap simplex fiber optic connections.

6. The high-density port tap fiber optic apparatus of claim 1, wherein:
the at least two live simplex fiber optic components or the at least one live duplex fiber optic component is comprised of at least one hundred forty-four (144) live simplex fiber optic components; and
the tap fiber optic connection density is comprised of at least one hundred forty-four (144) passive tap simplex fiber optic connections.

7. The high-density port tap fiber optic apparatus of claim 1, wherein:
the at least two live simplex fiber optic components or the at least one live duplex fiber optic component is comprised of at least forty-nine (49) live duplex fiber optic components; and
the tap fiber optic connection density is comprised of at least forty-nine (49) passive tap duplex fiber optic connections.

8. The high-density port tap fiber optic apparatus of claim 1, wherein:
the at least two live simplex fiber optic components or the at least one live duplex fiber optic component is comprised of at least sixty (60) live duplex fiber optic components; and
the tap fiber optic connection density is comprised of at least one sixty (60) passive tap duplex fiber optic connections.

9. The high-density port tap fiber optic apparatus of claim 1, wherein:
the at least two live simplex fiber optic components or the at least one live duplex fiber optic component is comprised of at least seventy-two (72) live duplex fiber optic components; and
the tap fiber optic connection density is comprised of at least seventy-two (72) passive tap duplex fiber optic connections.

10. The high-density port tap fiber optic apparatus of claim 1, wherein the at least two live simplex fiber optic components or the at least one live duplex fiber optic component is comprised of at least one live simplex fiber optic connector, at least one live duplex fiber optic connector, at least one live simplex fiber optic adapter, or at least one live duplex fiber optic adapter.

11. The high-density port tap fiber optic apparatus of claim 1, wherein the at least two live simplex fiber optic components or the at least one live duplex fiber optic component is disposed in at least one port tap fiber optic module.

12. The high-density port tap fiber optic apparatus of claim 1, wherein the at least two live simplex fiber optic components or the at least one live duplex fiber optic component is disposed in at least one port tap fiber optic module and the module further includes a cartridge.

13. The high-density port tap fiber optic apparatus of claim 1, wherein the chassis is further configured to support the live fiber optic connection density and the tap fiber optic connection density in a fiber optic equipment drawer disposed in the chassis.

14. A method of supporting a live and tap fiber optic connection density, comprising:
supporting a live fiber optic connection density of at least ninety-eight (98) live fiber optic connections per U space using at least one live simplex fiber optic component or live duplex fiber optic component; and
supporting a passive tap fiber optic connection density of at least ninety-eight (98) passive taps fiber optic connections in the U space supporting the live fiber optic connection density.

15. The method of claim 14, wherein;
wherein the at least two live simplex fiber optic components or the at least one live duplex fiber optic component is comprised of at least ninety-eight (98) live simplex fiber optic components; and
the tap fiber optic connection density is comprised of at least ninety-eight (98) passive tap simplex fiber optic connections.

16. The method of claim 14, wherein:
the at least two live simplex fiber optic components or the at least one live duplex fiber optic component is comprised of at least forty-nine (49) live duplex fiber optic components; and
the tap fiber optic connection density is comprised of at least forty-nine (49) passive tap duplex fiber optic connections.

17. A high-bandwidth port tap fiber optic apparatus, comprising:
a chassis having a size based on U space;
wherein the chassis is configured to support a full-duplex live connection bandwidth of at least nine hundred sixty-two (962) Gigabits per second per U space using at least two live simplex fiber optic components or one live duplex fiber optic component; and
wherein the chassis is further configured to support a passive tap connection bandwidth of at least nine hundred sixty-two (962) Gigabits per second per U space.

18. The high-bandwidth port tap fiber optic apparatus of claim 17, wherein the chassis is configured to support the full-duplex live connection bandwidth of at least one thousand two hundred (1200) Gigabits per second per U space, and the passive tap connection bandwidth of at least one thousand two hundred (1200) Gigabits per second per U space.

19. The high-bandwidth port tap fiber optic apparatus of claim 17, wherein the chassis is configured to support the full-duplex live connection bandwidth of at least one thousand four hundred forty (1440) Gigabits per second per U space, and the passive tap connection bandwidth of at least one thousand four hundred forty (1440) Gigabits per second per U space.

20. The high-bandwidth port tap fiber optic apparatus of claim 17, wherein:
the at least two live simplex fiber optic components or the at least one live duplex fiber optic component is comprised of at least ninety-eight (98) live simplex fiber optic components; and
the tap fiber optic connection density is comprised of at least ninety-eight (98) passive tap simplex fiber optic connections.

21. The high-bandwidth port tap fiber optic apparatus of claim 17, wherein:
the at least two live simplex fiber optic components or the at least one live duplex fiber optic component is comprised of at least one hundred twenty (120) live simplex fiber optic components; and
the tap fiber optic connection density is comprised of at least one hundred twenty (120) passive tap simplex fiber optic connections.

22. The high-bandwidth port tap fiber optic apparatus of claim 17, wherein:
the at least two live simplex fiber optic components or the at least one live duplex fiber optic component is comprised of at least one hundred forty-four (144) live simplex fiber optic components; and
the tap fiber optic connection density is comprised of at least one hundred forty-four (144) passive tap simplex fiber optic connections.

23. The high-bandwidth port tap fiber optic apparatus of claim 17, wherein:
the at least two live simplex fiber optic components or the at least one live duplex fiber optic component is comprised of at least forty-nine (49) live duplex fiber optic components; and
the tap fiber optic connection density is comprised of at least forty-nine (49) passive tap duplex fiber optic connections.

24. The high-bandwidth port tap fiber optic apparatus of claim 17, wherein:
the at least two live simplex fiber optic components or the at least one live duplex fiber optic component is comprised of at least sixty (60) live duplex fiber optic components; and
the tap fiber optic connection density is comprised of at least sixty (60) passive tap duplex fiber optic connections.

25. The high-bandwidth port tap fiber optic apparatus of claim 17, wherein:
the at least two live simplex fiber optic components or the at least one live duplex fiber optic component is comprised of at least seventy-two (72) live duplex fiber optic components; and
the tap fiber optic connection density is comprised of at least seventy-two (72) passive tap duplex fiber optic connections.

26. The high-bandwidth port tap fiber optic apparatus of claim 17, wherein the at least two simplex live fiber optic components or the one live duplex fiber optic component is comprised of at least one live simplex fiber optic connector, at least one live duplex fiber optic connector, at least one live simplex fiber optic adapter, or at least one live duplex fiber optic adapter.

27. The high-bandwidth port tap fiber optic apparatus of claim 17, wherein the at least two live simplex fiber optic components or the one live duplex fiber optic component is disposed in at least one port tap fiber optic module.

28. The high-bandwidth port tap fiber optic apparatus of claim 17, wherein the chassis is configured to support the live full-duplex connection bandwidth in a fiber optic equipment drawer disposed in the chassis.

29. A method of supporting a live and passive tap fiber optic connection bandwidth, comprising:
supporting a live full-duplex connection bandwidth of at least nine hundred sixty-two (962) Gigabits per second per U space using at least two live simplex fiber optic components or one duplex fiber optic component; and
supporting a passive taps connection bandwidth of at least nine hundred sixty-two (962) Gigabits per second in the U space supporting the live full-duplex connection bandwidth.

30. The method of claim 29, wherein supporting the live full-duplex connection bandwidth comprises providing a bandwidth of at least one thousand two hundred (1200) Gigabits per second per U space using the at least two live simplex fiber optic components or the one live duplex fiber optic component; and
supporting a passive taps connection bandwidth comprises supporting a passive taps connection bandwidth of at least one thousand two hundred (1200) Gigabits per second in the U space supporting the live full-duplex connection bandwidth.

31. The method of claim 29, wherein supporting the live full-duplex connection bandwidth comprises providing a bandwidth of at least one thousand four hundred forty (1440) Gigabits per second per U space using the at least two live simplex fiber optic components or the one live duplex fiber optic component; and
supporting a passive taps connection bandwidth comprises supporting a passive taps connection bandwidth of at least one thousand four hundred forty (1440) Gigabits per second in the U space supporting the live full-duplex connection bandwidth.
